(19) United States
(12) Patent Application Publication
(10) Pub. No.: US 2002/0054976 A1
(43) Pub. Date: May 9, 2002

(54) Molded glass substrate for magnetic disk and method for manufacturing the same

(76) Inventors: Shoji Nakamura, Osaka (JP); Takahisa Kondou, Sanda-shi (JP); Hidenao Kataoka, Osaka (JP); Yoshiyuki Shimizu, Osaka (JP)

Correspondence Address: ROSENTHAL & OSHA L.L.P., 1221 MCKINNEY AVENUE, SUITE 2800, HOUSTON, TX, 77010, US

(21) Appl. No.: 09/911,855

(22) Filed: Jul. 23, 2001

(30) Foreign Application Priority Data
Jul. 21, 2000 (JP) 2000-220801

(51) Int. Cl. B32B 3/10

(52) U.S. Cl. 428/66.6; 428/140; 65/61; 65/32.5; 65/66

(57) ABSTRACT

A molded glass substrate for a magnetic disk is manufactured in the following manner: press-molding a heated glass material in the inside space of a molding die including a pair of dies, each having a predetermined processing plane, and a barrel die for slidably guiding the dies while forming the outer circumference of the glass material joined to both principal surfaces corresponding to the dies as a molding-free face; cooling the press-molded glass substrate; and forming a predetermined through-hole in the central portion of the glass substrate. This method enables manufacturing that prevents generation of industrial waste, such as glass power, abrasive, and solvent, as much as possible.

### BACKGROUND OF THE INVENTION

1. Field of the Invention

The present invention relates to a molded glass substrate for a magnetic disk used in computer memory devices or the like and a method for manufacturing the same.

2. Description of the Related Art

In magnetic disks, the conflicting technological problems of high capacity and low cost have been addressed recently. To provide desired flatness and smoothness, a conventional disk, which uses aluminum as a base material, requires many complicated manufacturing processes by machining based on the methods of grinding and polishing. On the other hand, glass substrates with excellent rigidity and hardness are smoothed easily, so that they can satisfy high capacity and high reliability at the same time. However, there is a limit to the effort to reduce the cost because the conventional machining method is followed. The conventional machining method causes relatively a large amount of industrial waste during processing, such as glass powder, abrasive, and solvent, and treatment of the waste is not environmentally preferable. When a glass substrate for a magnetic disk is incorporated in actual equipment, dust is generated from the glass itself and alkaline component in the glass material is eluted. To suppress those phenomena, the entire surface of the glass substrate is mirror-finished.

For glass lenses in the field of optics, JP 62(1998)-292629 A discloses a molding apparatus for precisely transcribing the surface accuracy of a molding die onto a glass material while heating, pressing, and cooling the glass material. Also, a direct molding method has been proposed. Both have their advantages and disadvantages. Specifically, the former can achieve transcription with high accuracy because the temperature of a glass material approximates significantly to that of a die. However, it requires a lot of time for heating and cooling, and the molding process is divided so as to solve that problem. The latter is proposed as a manufacturing method for molding molten glass, having a low surface temperature and high internal temperature, directly with a die. Though this method can shorten preheating time remarkably, it has drawbacks in precise transcription and problems in energy measures, such as the need for annealing. The reason for this is as follows: high internal temperature of the glass and large eccentricity of thickness cause large contraction of the molded glass, so that large thermal distortion is maintained.

Therefore, it is advisable to use the combined techniques of the precision molding and machining methods to utilize their merits.

However, when a glass substrate is manufactured by conventional machining based on the methods of grinding and polishing as a molded glass substrate for a magnetic disk, glass powder as well as industrial waste, such as abrasive and solvent, are generated during processing, as described above. The glass substrate as a molded substrate for a magnetic disk requires many steps and is expensive. Since the glass substrate is a brittle material, fine glass is scattered from the processed portion, resulting in low reliability of the system.

### SUMMARY OF THE INVENTION

Embodiments of the present invention provide a glass substrate for a magnetic disk that is manufactured with a small number of steps so as not to generate industrial waste, such as glass powder, abrasive, and solvent. Embodiments of the present invention achieve low cost by reducing manufacturing processes of the substrate with a combination of precision molding and conventional machining so as to produce a doughnut-shaped glass substrate for a magnetic disk and solve the environmental problems by reducing machining processes as much as possible to decrease the discharge of industrial waste.

A molded glass substrate for a magnetic disk in accordance with embodiments of the present invention includes: upper and lower principal surfaces formed by molding between precision planar processing members; an outer surface joining the upper and lower principal surfaces, where the outer surface is a molding-free face; and an inner surface joining the upper and lower principal surfaces, the inner surface defining a through-hole in a central portion of the substrate.

A method for manufacturing a glass substrate for a magnetic disk in accordance with embodiments of the present invention includes: press-molding a heated glass material in the inside space of a molding die including a pair of dies, each having a predetermined processing plane, and a barrel die for slidably guiding the dies while forming the outer circumference of the glass material joined to both principal surfaces corresponding to the dies as a molding-free face; cooling the press-molded glass substrate; and forming a predetermined through-hole in the central portion of the glass substrate.

The present invention can provide embodiments that are desirable for environmental protection by reducing industrial waste as much as possible with a combination of a molding process and an existing machining process. Also, the present invention allows the outer circumference to be formed as a molding-free face, so that the surface property equivalent to that of a polished surface can be provided. This makes it possible to suppress the generation of dust from the glass itself and eliminate the need for chamfering. Moreover, using a grinding wheel and processing method of the present invention in boring can reduce the number of steps, resulting in cost reduction.

### BRIEF DESCRIPTION OF THE DRAWINGS

FIG. 1 is a perspective view illustrating a magnetic disk glass substrate obtained by Embodiment 1 of the present invention.

FIG. 2 is a main part cross-sectional view illustrating the configuration of a molding block used in Embodiments 2 and 3 of the present invention.

FIG. 3 is a main part cross-sectional view illustrating a press-molding method of Embodiment 2 of the present invention.

FIG. 4 is a perspective view illustrating a molded glass substrate obtained by Embodiments 2 and 3 of the present invention.

FIG. 5A is a main part cross-sectional view illustrating a preheating step of a press-molding method of Embodiment 3 of the present invention; FIG. 5B is a main part cross-sectional view illustrating a transforming step of the same, and FIG. 5C is a main part cross-sectional view illustrating a cooling step of the same.

FIG. 6 is a main part cross-sectional view illustrating manufacturing methods of Embodiments 4, 5, 6, 8, and 9 of the present invention.

FIG. 7 is a main part cross-sectional view of a mounted buffing wheel for explaining Embodiment 6 of the present invention.

FIG. 8 is a cross-sectional view of a mounted wheel for explaining Embodiment 7 of the present invention.

FIG. 9 is a cross-sectional view showing the device in the preheating, transforming, and cooling steps of a press-molding method in Embodiment 3 of the present invention that is placed in a chamber filled with an inert gas.

### DESCRIPTION OF THE PREFERRED EMBODIMENTS

For a glass substrate of the present invention, the outer surface of its circumference is formed as a molding-free face. The judgment about whether the surface is a molding-free face can be made by observing it with a scanning electron microscope (SEM) or the like. In the case of a polished surface, fine marks made by polishing are left. On the other hand, the molding-free face has a smooth surface.

It is preferable that the principal surface has an average surface roughness Ra of no greater than 0.5 nm, a maximum height Ry of no greater than 5.0 nm, a small waviness Wa of no greater than 0.5 nm, and accuracy of no greater than 3 μm in flatness. Those factors within the above range can prevent accidents, such as a crash, even if the magnetic disk rotates at high speed.

It is preferable that the inner surface is ground and polished.

More preferably, the inner surface is fire-polished. Here, the term “fire-polish” means the application of oxygen/hydrogen flame. This process can form a rounded edge without corners.

It is preferable that the glass substrate has a thickness of 0.3 mm to 1.0 mm and a diameter of 25.4 mm to 88.9 mm. The purpose of this requirement is to satisfy a magnetic disk in practical use.

In a manufacturing method of the present invention, it is preferable that the press-molding of a glass material includes the following: supplying a glass material to the inside space of the molding die; preheating and heating the glass material by heating the entire molding die; press-molding the glass material into a glass substrate in the temperature range that allows the glass material to be molded by pressure; and retrieving the glass substrate from the molding die after cooling.

Two systems can be used for heating and cooling the entire molding die: a batch system and a continuous system. The batch system performs the process with one heating/cooling device. The continuous system divides the process into the steps of preheating, transforming, and cooling and controls the temperature and pressure in each step with a heating body and a pressurizing mechanism that are controlled at least one steady temperature.

It is preferable that a holder for holding the outer surface of the glass substrate and not in contact with the principal surfaces is used in forming the predetermined through-hole in the central portion of the glass substrate.

It is preferable that the holder holds the outer surface of the glass substrate, and that boring, chamfering, and mirror-finishing of the end face of a bore are performed successively without changing the position at which the glass substrate is held.

It is preferable that a tool used for the boring, chamfering, and mirror-finishing of the end face of a bore is a diamond mounted wheel including a core-drill portion and a chamfer portion that are separated from each other and formed as an integral component.

It is preferable that the diamond mounted wheel has a plurality of chamfer portions that differ in particle size.

It is preferable that the boring, chamfering, and mirror-finishing of the end face of a bore are each performed by applying a coolant for cooling a grinding wheel and the glass substrate.

It is preferable that the boring, chamfering, and mirror-finishing of the end face of a bore are performed by a device that includes a workpiece-rotating shaft, a grinding wheel spindle, and a sliding portion: the workpiece-rotating shaft rotates while holding the outer circumference of the glass substrate; the grinding wheel spindle is located in parallel with the workpiece-rotating shaft; and the sliding portion allows one of the workpiece-rotating shaft and the grinding wheel spindle to move in the axial direction and in the direction perpendicular to the axial direction.

It is preferable that preheating, heating, and cooling are performed in a chamber filled with an inert gas to prevent deterioration of the glass material.

It is preferable that unusual projections are removed by polishing the glass substrate after press-molding with ceric oxide dispersing liquid or the like.

The following is a method for measuring an average surface roughness Ra, a maximum height Ry, a small waviness Wa, and flatness of the principal surface in the present invention.

(1) Average surface roughness Ra: the principal surface is measured at four locations within 10 μm² using an atomic force microscope (AFM). Then, the average of the surface roughness thus measured is calculated.

(2) Small waviness Wa: the principal surface is measured at four locations within 1 mm² using an interferometer. Then, the average of the small waviness thus measured is calculated.

(3) Maximum height Ry: the principal surface is measured at four locations within 10 μm² using an atomic force microscope (AFM). Then, the average of the maximum height thus measured is calculated.

(4) Flatness: the entire surface is evaluated using an interferometer.

### Embodiment 1

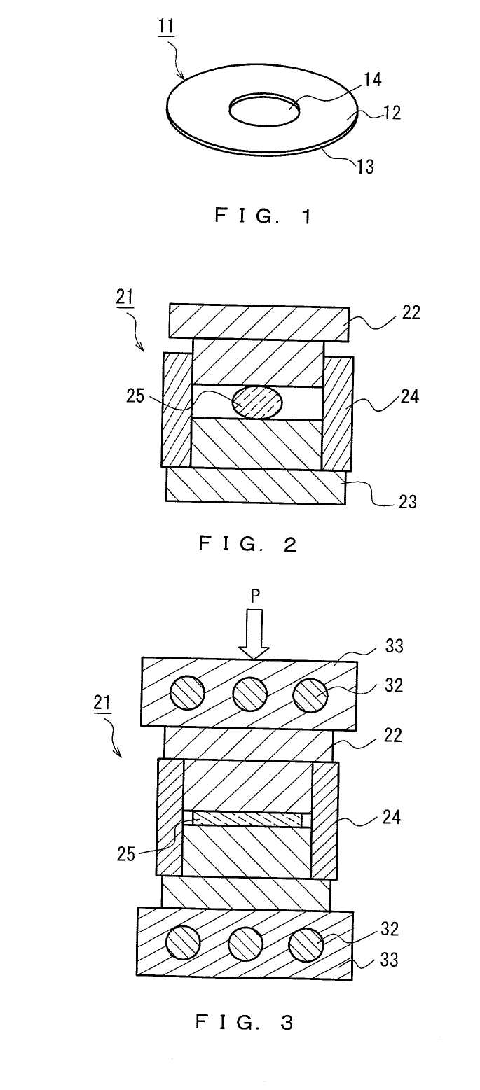

Hereinafter, a molded glass substrate for a magnetic disk of Embodiment 1 of the present invention will be described with reference to FIG. 1, and press-molding and processing methods for producing the molded glass substrate will be described with reference to FIGS. 2, 3, 4, and 5A to 5C.

FIG. 1 shows a molded glass substrate 11 for a magnetic disk, including principal surfaces 12, a molding-free face 13, and an inner surface 14: the principal surfaces 12 are formed on both sides of the substrate by precise press-molding; the molding-free face 13 is the outer surface joined to the principal surfaces; and the inner surface 14 is formed by precise machining.

The precisely processed surfaces of a molding die are transcribed faithfully onto the principal surfaces 12. The molding-free face 13 is not controlled by the processed surfaces of dies during molding. In general, the inner and outer circumferences of a magnetic disk glass substrate are ground and chamfered, and the principal surfaces are polished so as to provide a desired surface roughness and substrate thickness.

On the other hand, the molded glass substrate 11 for a magnetic disk of Embodiment 1 of the present invention suppresses the discharge of industrial waste, such as abrasive and grinding lubricant, as much as possible. Also, it suppresses the generation of dust from the glass itself because the molding-free face 13 is in the mirror-finished state. Though the inner surface is machined in a conventional manner, the use of a jig and a processing method, which will be described later, can prevent damage to the principal surfaces 12, reduce the number of steps, and achieve processing that suppresses industrial waste as much as possible, compared with a conventional processing method.

Hereinafter, the molded glass substrate for a magnetic disk of Embodiment 1 of the present invention and other Embodiments 2 to 10 for producing the substrate will be described.

### Embodiment 2

The schematic configurations of a molding die and a molding apparatus will be described with reference to FIGS. 2, 3, and 4.

In FIG. 2, a molding block 21 includes an upper die 22, a lower die 23, and a barrel die 24. Each of the upper and lower dies 22, 23 has a molding face that is processed precisely to have a desired mirror-finished surface. The barrel die 24 guides the upper and lower dies in a slidable fashion. A glass material 25 is placed in a space between the upper, lower, and barrel dies.

FIG. 3 shows the schematic configuration of a press-molding apparatus 31 that heats the entire molding block 21. The press-molding apparatus 31 includes upper and lower heating plates 33 arranged above and under the molding block 21, each heating plate containing a heater 32, and a mechanism for applying pressure via the upper heating plate 33, which is not shown and indicated by the arrow P in FIG. 3. Except for the pressurizing mechanism, the upper and lower heating plates 33 and the molding block 21 are placed in a chamber filled with an inert gas. In the embodiment shown in FIG. 3, the glass material 25 is preheated by heating the entire molding block 21 with the upper and lower heating plates 33. Then, the pressurizing mechanism applies pressure so that the upper die 22 comes into contact with the barrel die 24, and thus transformation of the glass material is completed. Thereafter, the power of the heaters in the upper and lower heating plates 33 is turned off, and the entire molding block is cooled while maintaining the pressure, and thus the press-molding is completed. The glass material 25 is subjected to axisymmetric transformation and does not touch the inner wall of the barrel die 24 when the upper die and the barrel die are in contact, and the outer surface of the glass material is formed as a molding-free face.

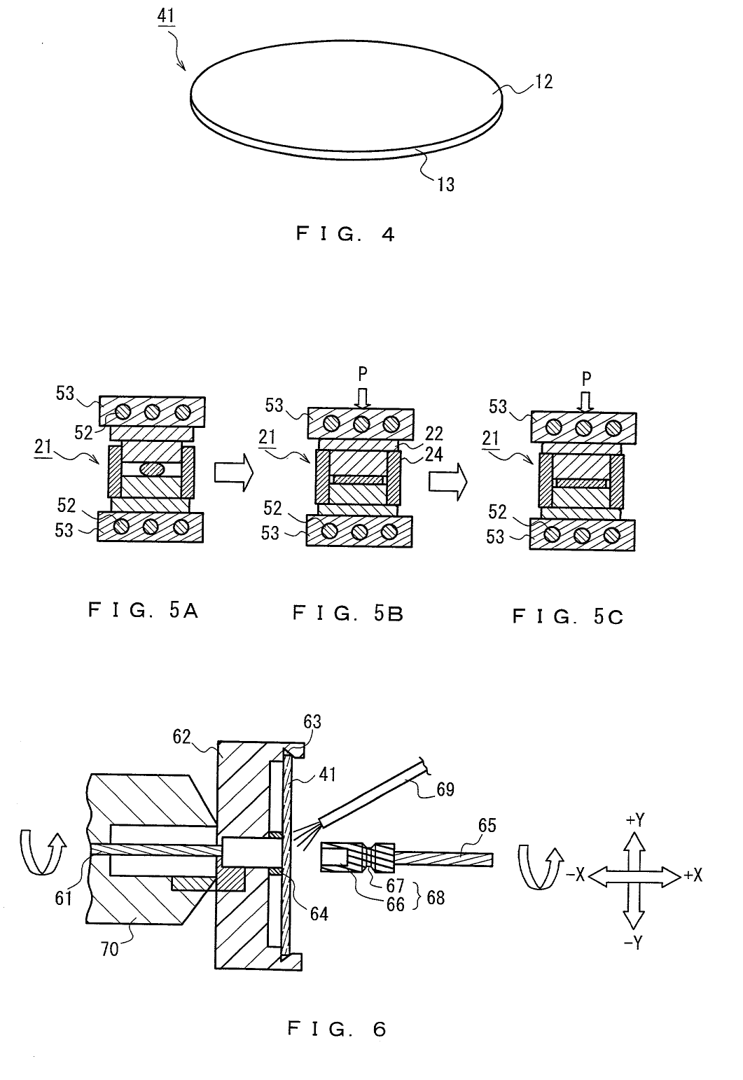

FIG. 4 shows a disk-shaped molded glass substrate 41 produced by the precise press-molding method described above. The molded glass substrate 41 has principal surfaces 12 on which a magnetic medium is formed, and a molding-free face 13, which is the outer surface. The mirror surface property of the molding die used is transcribed faithfully onto the principal surfaces, and the outer surface is a molding-free face in the mirror-finished state. In addition, the outer diameter satisfies a desired dimensional tolerance by selecting a predetermined volume of the glass material. The thickness of the molded glass substrate 41 also satisfies a desired dimension and tolerance by adjusting the barrel die size precisely.

Next, a method for producing the molded glass substrate 41 in FIG. 4 will be described more specifically, the method being carried out to obtain the molded glass substrate 11 for a magnetic disk of Embodiment 1 of the present invention shown in FIG. 1.

First, the method is explained with reference to FIGS. 2, 3, and 4.

The upper and lower dies 22, 23 use super-hard alloy as a base material. The molding face is provided with a protective film to prevent the adhesion of the glass material 25 and is mirror-finished. The molding face has an average surface roughness Ra of no greater than 0.5 nm, a maximum height Ry of no greater than 5 nm, a small waviness Wa of no greater than 0.5 nm, and accuracy of 3 micrometers in flatness. The barrel die 24 also uses super-hard alloy having an inner diameter of 30 mm, and the dimension of joints of the barrel die to the upper and lower dies is within 6 to 10 micrometers. For the glass material 25, aluminum silicate glass with thermal characteristics, i.e., a softening point of 665° C. and a glass transition point of 503° C., is melted into droplets having a weight of 580 mg. Using the glass material thus prepared, the molding block 21 is provided. As shown in FIG. 3, the molding block in contact with the upper and lower heating plates 33, each having the heater 32 embedded, is heated at a set temperature of the heater of 690° C. The heater reaches a predetermined temperature of 690° C. in about 8 minutes, and then a pressure P of 15000 N is applied via the upper heating plate 33 in the direction of the arrow in FIG. 3 so that the upper die 22 comes into contact with the barrel die 24. The time required for transformation is about 80 seconds. Then, the power of the heater is turned off, and the entire molding block is cooled while maintaining the pressure. After being cooled sufficiently, the molding block is disassembled to provide the molded glass substrate 41 shown in FIG. 4. The measurement with a micrometer confirmed that the molded glass substrate had a desired outer diameter of 27.4 mm and a desired substrate thickness of 0.38 mm. Also, the evaluation of flatness on both transcribed surfaces with a Fizeau interferometer confirmed that one surface was a concave surface of 2 micrometers and the other was a convex surface of 1 micrometer. The Ra and Ry were evaluated using an atomic force microscope (AFM). As a result, the Ra was the same as an average surface roughness of the molding die surface, but the Ry indicated partially unusual projections of several tens of nanometers. Concerning the small waviness Wa, the transcription property equal to that of the molding die surface was able to be confirmed. It was turned out that the above unusual projections were caused by minute pinholes on the molding die surface.

### Embodiment 3

Next, to obtain the molded glass substrate for a magnetic disk of Embodiment 1 of the present invention shown in FIG. 1, the concept of a press-molding method different from the above method will be described with reference to FIG. 5 so that the molded glass substrate 41 can be produced.

FIG. 5A shows a preheating step: a molding block 21 similar to that in FIG. 2 is preheated throughout with upper and lower heating plates 53, each of which is heated at a steady temperature and controlled by a heater 52, while the molding block 21 is kept waiting for a certain time. Then, the molding block 21 is conveyed to a transforming step shown in FIG. 5B. In the transforming step, a pressurizing mechanism (not shown) applies pressure P so as to transform a glass material 25, and the transformation is completed when an upper die 22 comes into contact with a barrel die 24 in the same manner as shown in FIG. 3. In FIG. 5C, a cooling step is performed with the application of pressure maintained via the upper and lower heating plates 53, which are controlled at the optimum steady temperature for cooling the entire molding block 21. After completion of the cooling, the molding block is disassembled to provide a molded glass substrate 41 similar to that shown in FIG. 4. The heating portion constituting any of the preheating, transforming, and cooling steps is placed in a chamber filled with an inert gas, e.g., N₂ gas. The pressurizing mechanism includes a device achieved by general techniques, such as an air cylinder or hydraulic cylinder.

The above two methods are possible to produce the molded glass substrate 41 shown in FIG. 4. Embodiment 2 can be applied to molding for relatively small amount of production, and Embodiment 3 can be applied to molding for large amount of production.

The detailed description is given by referring to FIGS. 5A to 5C. FIGS. 5A to 5C show the steps of preheating, transforming, and cooling successively. The molding block 21 in FIG. 5A is the same as that in FIG. 2. In the preheating step, the entire molding block 21 is heated between the upper and lower heating plates 53, each of which is controlled at a steady temperature of 450° C. The molding apparatus includes a plurality of stages of preheating (not shown) similar to that in FIG. 5A, and only the molding block is heated successively with the upper and lower heating plates that are controlled at steady temperatures of 550° C. and 650° C. Thus, the preheating step is completed. Next, the molding block is conveyed to the transforming step in FIG. 5B, where the steady temperature is controlled to 675° C., which is a transformation temperature. Then, the application of pressure P (23000 N) starts in the direction of the arrow in FIG. 5B so that the upper die comes into contact with the barrel die in about 50 seconds, and thus transformation is completed. Thereafter, the molding block 21 is conveyed to the cooling step, where it is cooled under the pressure applied via the upper and lower heating plates that are controlled at the steady temperatures of 620° C., 530°0 C., 480° C. and 300° C. Thus, the cooling step is completed. In the first stage of the cooling step, cooling is performed while reducing the applied pressure successively from a maximum of 17000 N to 5000 N, 800 N, and 500 N. The molding block is disassembled and the molded glass substrate 41 shown in FIG. 4 is retrieved. The same evaluation as that in Embodiment 2 was conducted on the molded glass substrate 41, and nearly the same transcription property was confirmed.

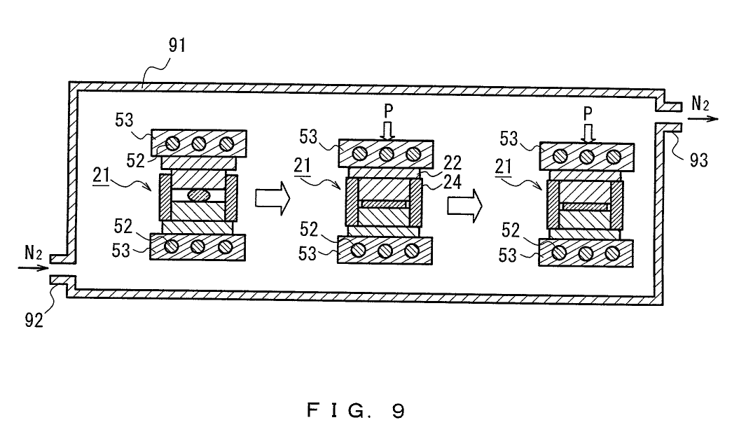

FIG. 9 shows an example of the device in FIGS. 5A to 5C that is placed in a chamber 91 filled with an atmosphere of N₂ gas, i.e., inert gas. The left in the chamber is the preheating step, the center is the transforming step, and the right is the cooling step. The N₂ gas is supplied to the chamber 91 through an inlet 92 and released from an outlet 93 to the outside. This configuration can prevent oxidation and deterioration of the glass material and achieve a stable molding.

### Embodiment 4

Using the molded glass substrate 41 produced according to Embodiments 2 and 3, a process of forming a central hole by holding the outer surface of the molded glass substrate will be described more specifically with reference to FIG. 6.

FIG. 6 shows a three-part split collet type, where a workpiece holder 62 is attached to a workpiece-rotating shaft 61, the holder 62 has a V-groove 63 in its inner circumference to hold the outer surface of the molded glass substrate 41, and the molded glass substrate 41 can be installed/removed on the holder 62 by loosening a fastener 70. To increase apparent strength during processing, a ring-shaped receiving portion 64 and the molded glass substrate are in contact at the center of the holder 62. The inside of the receiving portion 64 is used as a relief portion for a grinding wheel, which will be described later. Thus, the molded glass substrate is held with its principal surfaces, on which a magnetic medium is formed, not in contact with the holder 62, thus preventing scratches and dents. It is preferable that the holder is made of resin. However, a holder of metal may be used to increase accuracy of the holder itself.

### Embodiment 5

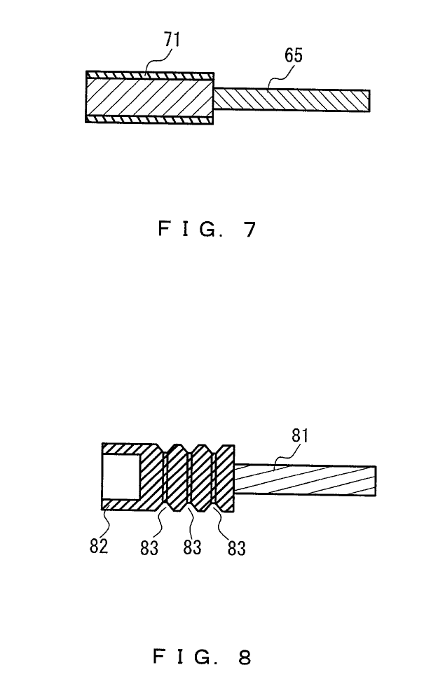

Referring to FIGS. 6 and 7, a grinding wheel spindle 65 provided in parallel with the workpiece-rotating shaft 61 has a mounted wheel 68 including a core drill 66 and a chamfer 67 that are formed as a integral component. Here, a sliding mechanism (not shown) is provided to allow either the workpiece-rotating shaft 61 or the grinding wheel spindle 65 to move in the direction perpendicular to both rotation axes, represented by +Y and −Y in FIG. 6, and in the direction parallel to those axes, represented by +X and −X in FIG. 6. Such a mechanism is well known to those skilled in the art as a cross-guide system or X−Y table system. The above configuration further includes a nozzle 69 that supplies working fluid to both the molded glass substrate 41 and the mounted wheel 68 as a coolant during processing. The use of equipment satisfying the above requirements, e.g., the internal grinding function of a commercially available cylindrical grinder, can achieve Embodiment 5 of the present invention. Specifically, the molded glass substrate 41 is installed in the holder 62 made of, e.g., Bakelite, which then is attached to the workpiece-rotating shaft 61 and rotated at 200 rpm in the direction of the arrows in FIG. 6. On the other hand, the mounted wheel 68 attached to the grinding wheel spindle 65 includes the core drill 66 and the chamfer 67: the core drill has an outer diameter of 6 mm at the front end and an inner diameter of 4 mm; the chamfer 67 is at the rear end of the core drill and has a trapezoidal shape, a flute width of 0.2 mm, and an open angle of 90 degrees. Diamond abrasive grains of #240 (“#” represents the number of meshes per 1 inch) are electro-deposited on the entire core drill and chamfer. Thus, rotation is made at 26000 rpm in the direction of the arrows in FIG. 6.

First, cutting is performed while moving the workpiece-rotating shaft 61 in the direction of the grinding wheel spindle 65 (the +X direction in the drawing), and thus core-drilling (i.e., boring) is completed. Then, the workpiece-rotating shaft is moved further in the same direction until the thickness direction of the molded glass substrate 41 and the chamfer 67 of the mounted wheel are located at a predetermined position. In this condition, cutting is performed while moving the workpiece-rotating shaft 61 in the −Y direction of FIG. 6 by 0.9 mm, and thus chamfering is completed. It was confirmed that the molded glass substrate thus processed had a desired inner diameter of 7 mm, and that the desired amount of chamfering was achieved as well. Moreover, the end face of the inner circumference of the molded glass substrate processed can be mirror-finished in the following manner: the workpiece-rotating shaft and the grinding wheel spindle are separated from each other, and a buffing wheel 71 shown in FIG. 7 is impregnated with a turbid solution of ceric oxide, which then is attached to the grinding wheel spindle 65 and rotated at 80 rpm. Thus, the molded glass substrate 11 for a magnetic disk described in Embodiment 1 of the present invention can be obtained. A grinding wheel spindle for mirror-finishing the end face of the inner circumference may be different from the grinding wheel spindle 65 for core-drilling and chamfering, as long as it has the same function as that of the grinding wheel spindle 65 and located in parallel with the workpiece-rotating shaft.

Embodiment 6 of the present invention can perform all the steps of core-drilling, chamfering, and mirror-finishing successively by holding the molded glass substrate 41 only once, resulting in a reduction in the number of steps.

### Embodiment 6

The mounted wheel 68 in Embodiment 5 includes the core drill 66 and the chamfer 67 that are formed as an integral component. This makes it possible to provide a grinding wheel that can perform two different processing functions with one device, thereby reducing the number of steps.

### Embodiment 7

An alternate embodiment to the mounted wheel 68 in Embodiment 5 will be described with reference to FIG. 8. FIG. 8 shows a mounted wheel 81 used in Embodiment 8 of the present invention. The mounted wheel 81 includes a core drill 82 at the front end and a plurality of chamfers 83 at the rear end, the core drill and the chamfers being formed as an integral component. Each of the core drill and the chamfer has the same size as those used in Embodiment 6. Diamond abrasive grains having a particle size of #240 (“#” represents the number of meshes per 1 inch) are electro-deposited on the core drill 82. Diamond abrasive grains having different particle sizes of #240, #400, and #800 are electro-deposited on the chamfers 83 for the first, the second, and the third chamfer from the front end, respectively. Like the method described in Embodiment 6, core-drilling and chamfering by the first to third chamfers are performed successively, and thus chamfering of the molded glass substrate 41 is completed. The surface roughness of the end face of the inner circumference thus processed is slightly inferior to that described in Embodiment 5 in terms of mirror surface property. However, the processing time required to form a mirror-finished surface can be shortened.

### Embodiment 8

This embodiment provides a processing device that can be used to process the inner circumference of a general polished glass substrate for a magnetic disk, in addition to the molded glass substrate 41 produced in Embodiments 2 and 3. The description of Embodiment 5 can be applied to this embodiment. Also, this embodiment can provide a processing device for the molded glass substrate for a magnetic disk that takes advantage of the characteristics of the present invention, including Embodiments 4 to 7.

### Embodiment 9

In this embodiment, the molded glass substrate 41 produced in Embodiments 2 and 3 is fire-polished at temperatures of about 800° C. or more by applying oxygen/hydrogen flame to the internal processing surface for a few seconds, instead of the mirror-finishing with a buffing wheel in Embodiment 6. As a result, the improvement in mirror surface property can be confirmed, though the shape after chamfering is deformed slightly due to bubbles generated on the surface. Optimization of heating temperature, time, or the like can improve the surface property. Here, a holder of metal is used for holding the molded glass substrate.

### Embodiment 10

As described specifically in Embodiment 2, each of the principal surfaces of the molded glass substrate 41 has unusual projections caused by minute pinholes on the molding die surface. The possibility of the above problems in processing a molding die and in material cannot be ignored, no matter how optimally the mirror surface property is improved. In view of this, the principal surfaces are polished with polyurethane foam containing a turbid solution of 2 wt % ceric oxide after processing in Embodiment 6. Thus, the unusual projections can be removed without decreasing accuracy of the molded glass substrate 41. This process is called mechanical polishing.

Embodiment 10 of the present invention can provide a method for manufacturing a molded glass substrate for a magnetic disk that includes the following steps: forming the molded glass substrate 41 by pressure, as produced in Embodiments 3 and 4; processing the substrate to have a doughnut shape; reinforcing the substrate chemically by a well-known technique; and polishing the principal surfaces to remove the unusual projections thereon.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A molded glass substrate for a magnetic disk comprising:
upper and lower principal surfaces formed by molding between precision planar processing members;
an outer surface joining the upper and lower principal surfaces, wherein the outer surface is a molding-free face; and
an inner surface joining the upper and lower principal surfaces, the inner surface defining a through-hole in a central portion of the substrate.

2. The molded glass substrate according to claim 1, wherein each of the principal surfaces has an average surface roughness Ra of no greater than 0.5 nm.

3. The molded glass substrate according to claim 1, wherein each of the principal surfaces has a maximum height Ry of no greater than 5.0 nm.

4. The molded glass substrate according to claim 1, wherein each of the principal surfaces has a small waviness Wa of no greater than 0.5 nm.

5. The molded glass substrate according to claim 1, wherein each of the principal surfaces has accuracy of no greater than 3 μm in flatness.

6. The molded glass substrate according to claim 1, wherein the inner surface is ground and polished.

7. The molded glass substrate according to claim 1, wherein the inner surface is fire-polished.

8. The molded glass substrate according to claim 1, having a thickness of 0.3 mm to 1.0 mm and a diameter of 25.4 mm to 88.9 mm.

9. A method for manufacturing a glass substrate for a magnetic disk comprising:
press-molding a heated glass material in an inside space of a molding die comprising a pair of dies, each having a predetermined processing plane, and a barrel die for slidably guiding the dies while forming an outer circumference of the glass material joined to both principal surfaces corresponding to the dies as a molding-free face;
cooling the press-molded glass substrate; and
forming a predetermined through-hole in a central portion of the glass substrate.

10. The method according to claim 9, wherein the press-molding of a glass material comprises:
supplying a glass material to the inside space of the molding die;
preheating and heating the glass material by heating the entire molding die;
press-molding the glass material into a glass substrate in a temperature range that allows the glass material to be molded by pressure; and
retrieving the glass substrate from the molding die after cooling.

11. The method according to claim 10, wherein a batch system is employed to perform heating and cooling of the entire molding die with one heating/cooling device.

12. The method according to claim 10, wherein a continuous system is employed to divide heating and cooling of the entire molding die into steps of preheating, transforming, and cooling and to control temperature and pressure in each step with a heating body and a pressurizing mechanism that are controlled at least one steady temperature.

13. The method according to claim 10, wherein a holder for holding an outer surface of the glass substrate and not in contact with the principal surfaces is used in forming the predetermined through-hole in the central portion of the glass substrate.

14. The method according to claim 13, wherein the holder holds the outer surface of the glass substrate, and boring, chamfering, and mirror-finishing of an end face of a bore are performed successively without changing a position at which the glass substrate is held.

15. The method according to claim 14, wherein a tool used for the boring, chamfering, and mirror-finishing of the end face of a bore is a diamond mounted wheel comprising a core-drill portion and a chamfer portion that are separated from each other and formed as an integral component.

16. The method according to claim 15, wherein the diamond mounted wheel has a plurality of chamfer portions that differ in particle size.

17. The method according to claim 14, wherein the boring, chamfering, and mirror-finishing of the end face of a bore are each performed by applying a coolant for cooling a grinding wheel and the glass substrate.

18. The method according to claim 14, wherein the boring, chamfering, and mirror-finishing of the end face of a bore are performed by a device including a workpiece-rotating shaft that rotates while holding the outer circumference of the glass substrate, a grinding wheel spindle that is located in parallel with the workpiece-rotating shaft, and a sliding portion that allows one of the workpiece-rotating shaft and the grinding wheel spindle to move in an axial direction and in a direction perpendicular to the axial direction.

19. The method according to claim 10, wherein preheating, heating, and cooling are performed in a chamber filled with an inert gas.

20. The method according to claim 9, wherein unusual projections are removed by polishing the glass substrate after press-molding with ceric oxide dispersing liquid.
